(19) United States
(12) Patent Application Publication
(10) Pub. No.: US 2024/0202594 A1
(43) Pub. Date: Jun. 20, 2024

(54) PRIVATE TRAINING OF ARTIFICIAL INTELLIGENCE

(71) Applicant: Rain Neuromorphics Inc., San Francisco, CA (US)

(72) Inventors: Maxence Rodolphe Pierre-Louis Ernoult, Paris (FR); Alexander Almela Conklin, San Jose, CA (US)

(21) Appl. No.: 18/538,633

(22) Filed: Dec. 13, 2023

Related U.S. Application Data
(60) Provisional application No. 63/432,635, filed on Dec. 14, 2022.

(51) Int. Cl. G06N 20/00

(52) U.S. Cl. CPC G06N 20/00

(57) ABSTRACT

A system includes an update module residing on an edge device. The update module receives training data for a model corresponding to an application. The model and the application are on the edge device. Training data specific to the edge device is generated at the edge device. The update module provides the training data to a learning system. The learning system is on the edge device and determines individualized weight updates for the model using the training data. The update module receives, from the learning system, the individualized weight updates and provides, to a remote server, the individualized weight updates. The remote server determines global weight updates based on the individualized weight updates and other individualized weight updates from other edge device(s). The edge device receives weight updates that are based on the global weight updates, Thus, training data generated on the edge devices remains on the edge device.

### CROSS REFERENCE TO OTHER APPLICATIONS

This application claims priority to U.S. Provisional Patent Application No. 63/432,635 entitled PRIVATE TRAINING OF ARTIFICIAL INTELLIGENCE filed Dec. 14, 2022 which is incorporated herein by reference for all purposes.

### BACKGROUND OF THE INVENTION

Artificial intelligence (AI), or machine learning, utilizes learning networks, such as deep neural networks, in order to solve a variety of problems. Learning networks typically include layers of weights that weight signals combined with activation layers that apply functions to the signals. Training involves determining an optimal (or near optimal) configuration of the set of weights. The structure of the learning network (e.g., number of layers, connectivity among the layers, dimensionality of the layers, the type of activation function, etc.) including the values of the weights are together known as a model. The model may be deployed onto an edge device, such as a smart phone, tablet, or laptop. After it is deployed, additional training of the model can take place on the device.

For example, an app to share photos or other content or to watch videos may be on a smart phone or other edge device. The app may also provide advertising content or recommendations (e.g. to view or purchase other related content) from a server to the user of the app. The advertising content and/or recommendations may be selected using the model associated with the app. In order to customize the advertising content and/or recommendations provided, additional training may be performed for the model after it is deployed on the edge device. For example, training data in the form of images viewed, captured, or shared (e.g. via the app) or videos viewed on the edge device may be used to update the weights in the model. The change in the weights affects the ads selected by the model for the user. For example, if a user views or captures images of cars, updates to the weights of the model may cause the app or server to select more advertising for cars or car-related products to be shown to the user.

This additional training customizes the model for the user of the edge device. However, another result may be that the model is overfit to the user. Thus, the data from other users of the app on other edge devices is desired to be taken into account in training the model. This may be accomplished by sending training data (e.g. a description of the images viewed or captured by the user) to the server associated with the app. The server aggregates the training data from multiple edge devices, performs training using the aggregated data, and determines global updates for the models. The server then sends to the edge devices the global updates.

Although global updates allow the training data from multiple users to be utilized in updating weights for the models deployed on edge devices, there are drawbacks. Providing the training data to the server may expose users' private information to the organization controlling the server and/or the app. For example, the videos viewed and/or the images captured may be sent to the server. This may be undesirable. In some cases, the app may send to the server weight updates determined for the model at the edge device instead of sending training data. However, this process may still expose the training data to the app and, therefore, to the organization controlling the app and server. Moreover, multiple apps using different models may co-exist on the edge device. Each of these apps may train their models, send training data or weight updates to the corresponding server, and receive their global updates. Edge devices such as smartphones may have limited communication bandwidth for uploading model updates and downloading global updates. Edge devices may also have a limited power budget and limited compute resources. This further complicates the training and updating process, particularly if multiple models are present. The use of a shallow model having few layers may partially account for some of these issues. However, improvements in training of models on edge devices are still desired.

### BRIEF DESCRIPTION OF THE DRAWINGS

Various embodiments of the invention are disclosed in the following detailed description and the accompanying drawings.

FIGS. 1A-1B depict an embodiment of a system for securely updating models for edge devices and the edge devices.

FIG. 2 depicts a block diagram of an embodiment of a system for securely updating models for edge devices.

FIG. 3 depicts a block diagram of an embodiment of a system for securely updating models for edge devices.

FIG. 4 depicts a block diagram of an embodiment of a learning system usable for edge devices.

FIG. 5 depicts a block diagram of an embodiment of a compute engine for a learning system usable for edge devices.

FIGS. 6A-6B depict an embodiment of a learning system usable for edge devices.

FIG. 7 is a flow chart depicting an embodiment of a method for securely updating models for edge devices.

FIG. 8 is a flow chart depicting an embodiment of a method for securely updating models for edge devices.

FIG. 9 is a flow chart depicting an embodiment of a method for securely updating models for edge devices.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A system including an update module residing on an edge device is disclosed. The update module is configured to receive training data for a model corresponding to an application. The model, which includes weights, and the application are on the edge device. At least a portion of the training data is generated at the edge device and is specific to the edge device. The update module is configured to provide the training data to a learning system. The learning system resides on the edge device and determines individualized weight updates for the model using the training data. The update module is configured to receive, from the learning system, the individualized weight updates and to provide, from the edge device to a remote server, the individualized weight updates. The remote server determines global weight updates for the model based on the individualized weight updates from the edge device and other weight updates for the model from different edge device(s). The edge device receives weight updates for the model that are based on the global weight updates. Thus training data generated on the edge devices remains on the edge device.

In some embodiments, the edge device includes additional application(s) and additional model(s) corresponding to the additional application(s). In such embodiments, the update module further receives additional training data for the additional model(s). At least a portion of the additional training data is generated at the edge device and is specific to the edge device. The additional model(s) include additional weights. The update module also provides the additional training data to the learning system. The learning system determines additional individualized weight updates for the additional model(s) using the additional training data. The update module receives, from the learning system, the additional individualized weight updates. The update module also provides, from the edge device to the remote server, the additional individualized weight updates for the model. The remote server determines additional global weight updates for the additional model(s) based on the additional individualized weight updates from the edge device and additional distinct individual weight updates for the additional model(s) from distinct edge device(s). The edge device receives additional weight updates for the additional model(s). The additional weight updates are based on the additional global weight updates. The additional training data remains on the edge device. In some such embodiments, the learning system includes multiple learning subsystems. Each learning subsystem is configured for one of the models.

The update module may be configured to encrypt the individualized weight updates and to provide the encrypted individualized weight updates to the server. In some embodiments, the learning system includes a hardware vector-matrix multiplication accelerator. In some embodiments, the weight updates are received by the update module and provided by the update module to the learning system. The edge device may include additional component(s) that generate the training data. The update module may receive the training data from the additional component such that the training data remains separate from the application. The weight updates may be received at the edge device from an application server corresponding to the application. In some embodiments, the update module is configured such that at least the portion of the training data and the individualized weight updates remain separate from the application server. In some embodiments, no part of the at least the portion of the training data leaves the edge device for updating of the model.

A method is disclosed. The method includes receiving training data for a model corresponding to an application. The model, which includes weights, and the application are on the edge device. At least a portion of the training data is generated at the edge device and is specific to the edge device. The training data is provided to a learning system. The learning system resides on the edge device and determines individualized weight updates for the model using the training data. The method also includes receiving, from the learning system, the individualized weight updates and providing, from the edge device to a remote server, the individualized weight updates. The remote server determines global weight updates for the model based on the individualized weight updates from the edge device and other weight updates for the model from different edge device(s). The edge device receives weight updates for the model that are based on the global weight updates. Thus training data generated on the edge devices remains on the edge device. In some embodiments, the edge devices include additional application(s) and additional model(s) corresponding to the additional application(s). In such embodiments, an analogous method is carried out for the additional model(s), the additional application(s) and additional training data generated at the edge device and specific to the edge device.

In some embodiments, the individualized weight updates are encrypted and the encrypted individualized weight updates provided to the server. In some embodiments, the learning system includes a hardware vector-matrix multiplication accelerator. The edge device may include additional component(s) that generate the training data. The training data from the additional component may be received and provided to the learning system such that the training data remains separate from the application. The weight updates may be received at the edge device from an application server corresponding to the application. In some embodiments, at least the portion of the training data and the individualized weight updates remain separate from the application server. In some embodiments, no part of the at least the portion of the training data leaves the edge device for updating of the model.

A computer program product embodied in a non-transitory computer readable medium and comprising computer instructions is described. The computer instructions include computer instructions for receiving training data for a model corresponding to an application. The model, which includes weights, and the application are on the edge device. At least a portion of the training data is generated at the edge device and is specific to the edge device. The computer instructions include instructions for providing the training data to a learning system. The learning system resides on the edge device and determines individualized weight updates for the model using the training data. The computer instructions are for receiving, from the learning system, the individualized weight updates and providing, from the edge device to a remote server, the individualized weight updates. The remote server determines global weight updates for the model based on the individualized weight updates from the edge device and other weight updates for the model from different edge device(s). The edge device receives weight updates for the model that are based on the global weight updates. Thus training data generated on the edge devices remains on the edge device. In some embodiments, the edge devices include additional application(s) and additional model(s) corresponding to the additional application(s). In such embodiments, an analogous method is carried out for the additional model(s), the additional application(s) and additional training data generated at the edge device and specific to the edge device.

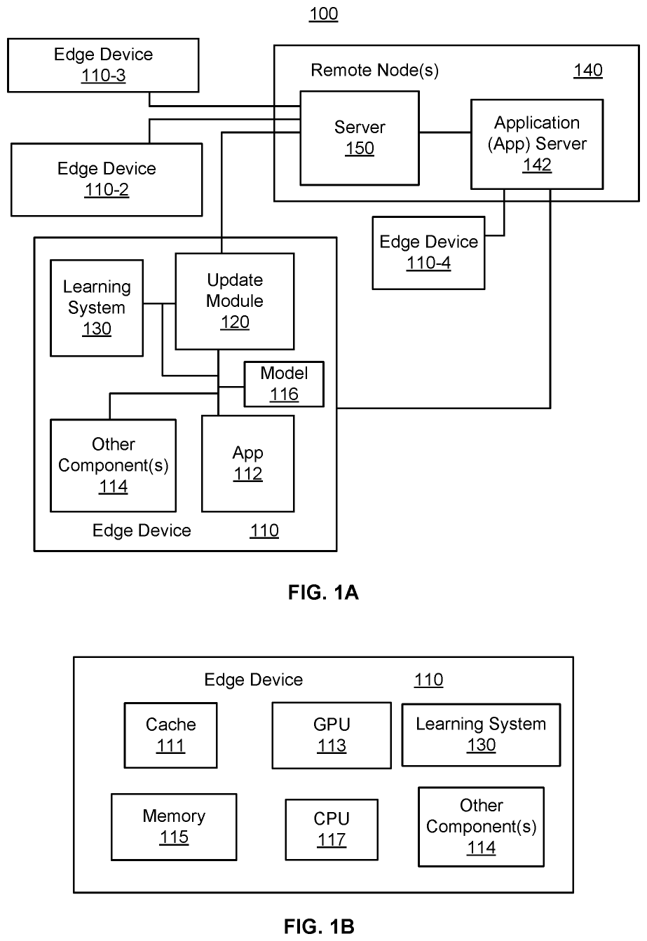

FIGS. 1A-1B depicts an embodiment of system 100 for securely updating models for edge devices. FIG. 1A depicts a block diagram of system 100, while FIG. 1B indicates some hardware components of edge device 110. Referring to FIG. 1A, system 100 includes edge device 110, edge devices 110-2, 110-3, and 110-4 (also collectively termed edge devices 110), and remote node(s) 140. In some embodiments, other and/or different components may be included in system 100.

Edge device 110 includes application (app) 112, other components 114, model 116, update module 120, and learning system 130. Other and/or different components may be present in edge device 110. Examples of edge device 110 include but are not limited to desktop computers, laptop computers, notebook computers, tablets, smart phones, gaming or virtual reality devices, and/or other mobile devices. Thus, edge devices 110 may thus have limited compute power, limited external communication bandwidth, limited memory, and/or limited power supply (e.g. battery).

Referring to FIG. 1B, edge device 110 includes cache 111, optional graphics processing unit (GPU) 113, memory 115, central processing unit (CPU) 117, additional component(s) 114 (e.g. cameras, speakers, input/output), and learning system 130. In some embodiments additional and/or different components may be present. In some embodiments, some components, such as GPU 113 and/or learning system 130, may be omitted. For example, in general, GPU 113 is not present on edge device 110. Components 111, 113, 114, 115, 117, and/or 130 may be used in providing the functions of app 112, other component(s) 114, model 116, and update module 120. For example, in some embodiments learning system 130 may be used by model 116 to perform an inference. For ease of explanation, model 116 is discussed as being separate from learning system 130. However, as mentioned more fully below, learning system 130 may be used to implement model 116 (e.g. to store weights and perform inferences). Thus, learning system 130 may be or include a hardware or other artificial intelligence (AI) accelerator usable by model 116/app 112 for performing inferences and by update module 120 for training model 116. CPU 117 may execute instructions using in providing app 112 and/or update module 120. Update module 120 may utilize cache 111, GPU 113, and/or learning system 130 in performing training for model 116. Similarly, update module 120 may use CPU 117 in performing encryption, data obfuscation, inferences, and/or other processing. Learning system 130 may be used in performing inferences and/or weight updates. Memory 115 may be used by update module 120 for storing local data and storing targets (used in training model 116). Local data may include images or other information stored or accessed via other components 114. Model 116 may be stored in a hierarchy of memories, such as in memory 115 and/or cache 111. Weights for the model may be stored in learning system 130. Thus, model 116 is not indicated.

Referring to FIGS. 1A-1B, remote node(s) 100 are generally physically distant from edge devices 110 and accessed via a network (e.g. the Internet). For example, remote node(s) 140 may be at a data center. Remote node(s) 140 includes a server 150 and application (app) server 142. Server 150 communicates with update module 120. Edge devices 110-2, 110-3, and 110-4 are analogous to edge device 110. Although four edge devices 110 are shown, in some embodiments, a large number of edge devices are present. Some or all of such edge devices include update module 120 and, optionally, learning system 130. Edge devices 110-2 and 110-3 each include an update module analogous to update module 120 that communicates with server 150. Edge device 110-4 does not include an update module and thus may communicate directly with app server 142. In some embodiments, edge device 110-4 may communicate with server 150. In such embodiments, server 150 not only aggregates weight updates determined by edge devices 110, 110-2, and 110-3, but may also determine and aggregates weight updates for edge device 110-4. Although depicted in a single block 140, server 150 and app server 142 may be co-located (e.g. at the same data center) or separate (e.g. at different data centers). Further, the same or different entities (e.g. organizations/companies) may control server 150 and app server 142.

App 112 on edge device 110 communicates with app server 142 and uses model 116. In some embodiments, app 112 may be a lightweight application (e.g. having a small memory footprint and limited usage of resources of edge device 110). Further, app 112 may be only one of a number of apps on edge device 110. App 112 and/or model 116 may be provided by the organization controlling app server 142. Model 116 may be a pre-trained machine learning model. In some embodiments, model 116 may not be pre-trained and instead may undergo its training on edge device 110. Model 116 may include multiple layers of weights interleaved with activation layers including neurons and applying activation function(s). In some embodiments, model 116 may be a shallow neural network (e.g. not more than ten layers, not more than five layers, not more than four layers, or not more than three layers deep). However, in some embodiments, model 116 may be a deeper neural network. Model 116 may be implemented with or without a hardware accelerator. If pre-trained, model 116 may include default weights that may have been provided based on training data that is not specific to edge device 110. However, model 110 is desired to be customized using at least training data generated and/or collected by and/or for edge device 110 (i.e. specific to edge device 110) and/or using training data generated and/or collected by and/or for remaining edge devices 110. Stated differently, model 116 is desired to be updated based upon training data specific to edge device 110.

For example, app 112 may be an application that a user of edge device 110 can employ to share and/or receive images, video, audio, and/or other content via edge device 110. The content may be captured on edge device 110 and/or otherwise accessible via edge device 110 (e.g. from a site on the Internet). App 112 may also be usable for other tasks. Organization controlling app server 142 may desire to share advertisements and/or other content with the user of edge device 110 that a user of edge device 110 is deemed to be interested in or engaged by. To do so, the interests of the user of edge device 110 may be ascertained based on data available at edge device 110. Based on these interests the corresponding content is selected. App 112 may communicate with (e.g. run) model 116 that is configured to aid in selection of advertisements and/or other content for the user. For example, model 116 may be configured to recognize images and/or audio captured by and/or downloaded to edge device 110. These images and audio may not have been captured, downloaded, or otherwise used in conjunction with app 112. Thus, the content which model 116 recognizes need not come from app server 142. Based on the content identified by model 116, individualized advertisements and/or other content may be provided to app 112 by app server 142.

Initially (before weights in model 116 have been updated based on training data specific to edge device 110), weights in model 116 have default values. To customize model 116, training data specific to edge device 110 is desired to be used in adjusting the weights for model 116. In the example above, updating the weights for model 116 may improve the model's ability to identify content viewed by the user of edge device 110. For example, components 114 may include a microphone, camera, input/output device, and/or communication system for accessing remote content. Images captured (e.g. by camera), images viewed (e.g. on the internet via the communication system), music (e.g. input via the microphone or accessed via the communication system) indicate the user's preferences and are desired to be used in updating model 116. However, such information may be private. Stated differently, a user may not desire such information to be provided by app 112 (or other component of edge device 110) to app server 142.

Update module 120 and learning system 130 (if present) may be used to update the weights for model 116 while maintaining the user's privacy. More specifically, update module 120 and learning system 130 may be used to update the weights for model 116 while limiting or preventing exposure of training data specific to edge device 110 to app server 142 and, in some embodiments, app 112. Further, update module 120 may manage communication with remote node(s) 140 to control the communication bandwidth used, the power drawn, and/or other tasks that affect performance and/or reliability of edge device 110. Although depicted as separate modules, update module 120 and learning system 130, which performs training, may be combined.

In operation, update module 120 receives training data. Some or all of this training data is specific to edge device 110. For example, training data may include images, video, and/or audio captured by other components 114, data input by a user of edge device 110, content downloaded to edge device 110, identification of Internet sites visited via edge device 110, and/or other with which data edge device 110 has interacted. Update module 120 may also receive targets for model 116, losses for model 116 (e.g. a measure of the difference between the targets and the output of model 116), the model 116, and/or other information. Targets may be received from app server 142 and/or from app 112. For example, if additional processing by app 112 is utilized for the targets, then update module 120 receives the targets from app 112.

Based on the training data, targets, and/or other information, individualized updates to the weights are determined. Stated differently individualized, or locally trained, weight updates are determined. In some embodiments, update module 120 performs training and determines individualized weight updates. In some embodiments, this is accomplished in conjunction with learning system 130. For example, learning system 130 may include or consist of a hardware or other AI accelerator that more efficiently performs inference and/or training. As such, learning system 130 may also be used to perform more efficiently some or all of the tasks of model 116. Stated differently, model 116 may be implemented using learning system 130. However, for ease of explanation and to separate the discussion of weight updates from inference, model 116 is discussed as being separate from learning system 130. Update module 120 provides the targets, the loss function, and/or the training data specific to edge device 110 to learning system 130. To determine the individualized weight updates, learning system 130 may be used to implement backpropagation or other learning techniques including but not limited to: alternative gradient computation algorithms, gradient preconditioning algorithms. In some embodiments, one or more of these and/or other techniques may be used in combination with optimization techniques for a given weight update value.

Update module 120 receives the individualized weight updates for model 116 from learning system 130. In some embodiments, the individualized weight updates are provided from update module 120 to model 116. Stated differently, the weights for model 116 may be updated using the individualized weight updates. However, in other embodiments, the individualized weight updates are not provided to model 116. In some embodiments, update module 120 provides the individualized weight updates to server 150. In some embodiments, only the updates to the weights are provided to server 150. In some embodiments, the updated weights are provided to server 150. For simplicity, system 100 is described in the context of the individualized weight updates being provided by update module 120 to server 150.

In some embodiments, update module 120 encrypts and/or otherwise obfuscates the individualized weight updates before providing the individualized weight updates to server 150. For example, update module 120 may introduce noise into the (encrypted or unencrypted) individualized weight updates. The noise is configured such that it is challenging to uncover the training data specific to edge device 110 but training is not significantly adversely affected. Update module 120 utilizes a secure and/or encrypted channel for communication with server 150. Thus, even the individualized weight updates may have additional layer(s) of protection. In some embodiments, update module 120 also provides weight updates (encrypted or unencrypted) to app 112.

In some embodiments, update module 120 automatically schedules the transmission of the individualized weight updates to server 150. For example, update module 120 may arbitrate between other communications and/or send the individualized weight updates (or otherwise sync with remote node(s) 140) only if edge device 110 has access to an external power source (e.g. is plugged in) and/or at night.

Update module 120 may use quantization of information to provide easier and faster training and inference. Quantization is a model size reduction technique that converts weights from a high-precision representation to a low-precision representation. In some embodiments, update module 120 performs local training with the quantized model 116. Thus, update module 120 may use minimal memory and processing capacity on the on-board processor. Power usage may, therefore, also be reduced. Pipelines may be used for non-weight data (and/or weight data) including but not limited to sharing activation, pre-activation, errors, gradients, and/or other information. In some embodiments, update module 120, and any other component of edge device 110, do not provide training data specific to edge device 110 to server 150 or app server 142. Stated differently, the training data specific to edge device 110 does not leave edge device 110 unless and a user or other entity expressly consents to the training data being shared.

Server 150 aggregates the individualized weight updates (and/or weights) from many edge devices 110, 110-2, and 110-3 running update module 120 and provides global weight updates. For example, server 150 may provide the mean, median, maximum, minimum, or other statistical measure of the individualized weight updates as the global weight updates. Thus, system 100 transitions towards improved quality of trained weights across multiple devices 110. The global weight updates may then be sent back to edge devices 110 using update modules such as update module 120. In some embodiments, the global weights are updated and sent to edge devices 110. In some embodiments, global weight updates are sent to edge devices 110, which update their weights. In some embodiments, the global weight updates are provided to app server 142. In such embodiments, app server 142 provides weight updates (or updated weights) to edge devices 110, for example via app 112. App server 142 may simply forward the global weight updates (or updated global weights) to edge devices 110. In some embodiments, app server 142 may perform additional processing to the global weight updates (or updated global weights).

In some embodiments, training data from edge device 110-4 is also incorporated into the updates provided to edge devices 110. In some embodiments, app server 142 receives training data from edge device 110-4 and determines the individualized weight updates for edge device 110-4. In some embodiments, app server 142 receives locally trained weight updates from edge device 110-4. In such embodiments, these locally trained weight updates may be provided from an application analogous to app 112. App server 142 may incorporate the locally trained weight updates from edge device 110-4 not including an update module (and/or analogous devices that are not shown) into the global weight updates provided by server 150. For example, app server 142 may determine the mean, median, maximum, minimum or other measure of the individualized weight updates for all edge devices 110 (i.e. 110, 110-2, 110-3, and 110-4). In some embodiments, these tasks are performed by server 150 as part of the determination of the global weight updates and/or global weights. Using server 150 and/or app server 142, weight updates that include information from edge devices 110, 110-2, and 110-3 including update module 120 and information from edge device(s) 110-4 that do not include update module 120 can be used to update the weights. The weight update incorporating information from edge devices 110 may be provided to edge devices 110, for example via apps analogous to app 112 and/or update modules. Edge devices 110 then update their weights. In some embodiments, the weights for all edge devices 110 are updated by app server 142 and the updated weights provided by app server 142 to edge devices 110.

Thus, weight updates for edge devices may be determined at remote node(s) 140 without direct, individualized training information from some or all edge devices 110. In some embodiments, server 150 may combine quantized weights sent to remote node(s) 140 by update modules 120 in a manner that overcomes the bias introduced by quantized training on edge devices 110. Server 150 aggregates weight information (including individualized, locally trained weight updates) from many edge devices 110 using update module 110. The aggregated trained information (e.g. global weight updates and/or updated global weights) is supplied to app server 142 and edge devices 110. Apps 112 and models 116 can then use the trained information to perform the desired tasks, such as recommendations, advertising, and/or providing other content. In some embodiments, the weight information provided to edge devices incorporates information from edge devices 110-4 that do not utilize update module 120. Although training data from such edge devices 110-4 may be used in determining updates to the weights of model 116, the private information for such edge devices 110-4 does not enjoy the enhanced security of edge devices 110, 110-2, and 110-3.

Thus, using system 100 including update modules 120 on edge devices 110, training data specific to edge devices 110 may be used in training model 116 (and learning system 130) on edge devices 110. This may be accomplished without exposing private data, such as the content viewed, to app server 142 or the organization controlling app server 142. Thus, security of private information for edge devices 110 may be improved. Update modules 120 may also improve power management and bandwidth management by arbitrating between training and updating model 116 and other tasks to be performed by edge device 110. Moreover, this improvement in security can be incorporated into a system having edge devices 110 using update module 120 as well as edge devices 110-4 not using update module 120. Performance of the trained network may thus be improved while allowing for flexibility in the edge devices used.

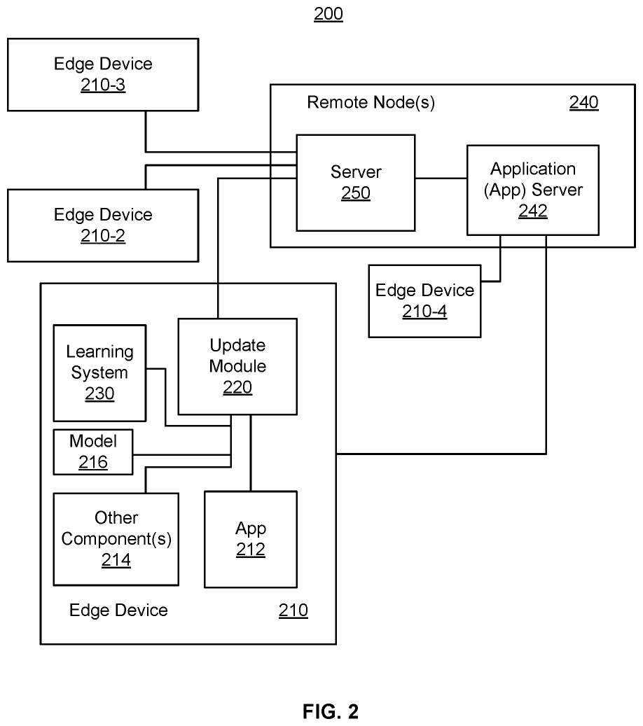

FIG. 2 depicts a block diagram of an embodiment of system 200 for securely updating models for edge devices. System 200 is analogous to system 100. For clarity, only a portion of system 200 is shown. Thus, system 200 may include additional and/or other components. System 200 is analogous to system 100. Consequently, similar components have analogous labels. System 200 includes edge devices 210, 210-2, 210-3, and 210-4, remote node(s) 240, server 250, and app server 242 that are analogous to edge devices 110, 110-2, 110-3, and 110-4, remote node(s) 140, server 150, and app server 142, respectively. Edge device 210 includes app 212, other components 214, model 216, update module 220, and learning system 230 that are analogous to app 112, other components 114, model 116, update module 120, and learning system 130, respectively. Consequently, system 200 operates in an analogous manner to system 100.

In addition, edge device 210 is configured such that app 212 does not have direct access to data from other components 214. As a result, training data from other components 214 may be utilized in updating weights for model 216. However, app 212, and thus app server 242, may not have access to such training data without explicit permission by a user of edge device 210. For example, other components 214 may be used to capture images or access video separately from the functions of app 212. For example, such images or video may not be desired to be shared by a user of edge devices 210 via app 212. In system 200, such data is inaccessible by app 212 unless access is explicitly granted (e.g. by dragging icons corresponding to the data into the appropriate folder in a GUI). However, such information may still be used by update module 220 to perform training. Because update module 220 is used, the training information specific to edge device 210 is not transmitted from edge device 210.

System 200 may share the benefits of system 100. Training data specific to edge devices 210 may be used in training model 216 (and learning system 230) on edge devices 210. This may be accomplished without exposing private data, such as the images captured by other components 214, to app server 242 or the organization controlling app server 242. Thus, security of private information for edge devices 210 may be improved. Security may be further enhanced by limiting or precluding access by app 212 of information from other components 214 without explicit approval by the user. Update modules 220 may also improve power management and bandwidth management by arbitrating between training and updating model 216 and other tasks to be performed by edge device 210. Moreover, this improvement in security can be incorporated into a system having edge devices 210 using update module 220 as well as edge devices 210-4 not using update module 220. Performance of the trained network may thus be improved while allowing for flexibility in the edge devices used.

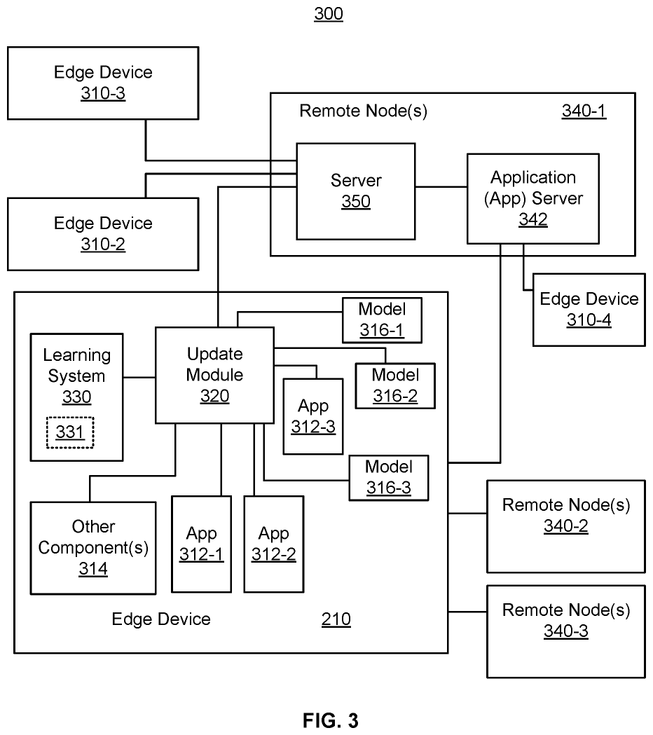

FIG. 3 depicts a block diagram of an embodiment of system 300 for securely updating models for edge devices. System 300 is analogous to system 100. For clarity, only a portion of system 300 is shown. Thus, system 300 may include additional and/or other components. System 300 is analogous to system 100. Consequently, similar components have analogous labels. System 300 includes edge devices 310, 310-2, 310-3, and 310-4, remote node(s) 340-1, server 350, and app server 342 that are analogous to edge devices 110, 110-2, 110-3, and 110-4, remote node(s) 140, server 150, and app server 142, respectively. Edge device 310 includes app 312, other components 314, model 316, update module 320, and learning system 330 that are analogous to app 112, other components 114, model 116, update module 120, and learning system 130, respectively. Consequently, system 300 operates in an analogous manner to system 100.

In addition, edge device 310 includes multiple apps 312-1 (analogous to app(s) 112 and/or 212), 312-2, and 312-3. Apps 312-1, 312-2, and 312-3 utilize models 316-1 (analogous to model(s) 116 and/or 216), 316-2, and 316-3, respectively. Apps 312-1, 312-2, and 312-3 communicate with remote nodes 340-1 (analogous to remote node(s) 140 and/or 240), 340-2, and 340-3. Although not depicted remote nodes 330-2 and 330-3 include app servers analogous to app server 342. Further, nodes 330-2 and 330-3 may have servers corresponding to server 350. In some embodiment(s), node(s) 330-2 and/or 330-3 do not have such servers. In such embodiments, server 350 may be used by remote nodes 330-2 and 330-3 as well as by apps 312-2 and 312-3 and models 316-2 and 316-3. In the embodiment shown, update module 320 and learning system 330 are used to perform local training for models 316-2 and 316-3 and provide individualized weight updates for models 316-2 and/or 316-3. Update module 320 is used in determining individualized weight updates for, arbitrating communication (e.g. synching) with corresponding servers, managing bandwidth requirements of, and/or updating weights for models 316-1, 316-2, and 316-3 and apps 312-1, 312-2, and 312-3. Thus, resource management, for example, power and bandwidth, may be improved. In some embodiments, learning system 330 may include optional subsystems 331 (indicated by dashed line). Thus, learning system 330 may include subsystems that are dedicated to a particular model 316-1, 316-2, or 316-3. In some embodiments, separate learning systems 330 may be used for each model 316-1, 316-2, and 316-3 or a subset of models 316-1, 316-2 and 316-3. In other embodiments, a single learning system 330 may be used for all models 316-1, 316-2, and 316-3.

System 300 may share the benefits of system 100. Training data specific to edge devices 310 may be used in training model 316 (and learning system 330) on edge devices 310. This may be accomplished without exposing private data, such as the content viewed, to app servers 342 or the organization controlling app server 342. Thus, security of private information for edge devices 310 may be improved. In some embodiments, security may be further enhanced by limiting or precluding access by app(s) 312-1, 312-2, and/or 312-3 of information from other components 314 without explicit approval by the user. Update module(s) 320 may also improve power management and bandwidth management by arbitrating between training multiple models 316-1, 316-2, and 316-3, updating multiple models 316-1, 316-2, and 316-3, and performing other tasks on edge device 310. Moreover, this improvement in security can be incorporated into a system having edge devices 310 using update module 320 as well as edge devices 310-4 not using update module 320. Performance of the trained network may thus be improved while allowing for flexibility in the edge devices used.

Update modules 120, 220, and 320 and servers 150, 250, and 350 are shown in systems 100, 200, and 300, respectively, having particular features highlighted. However, the features described herein may be combined in manners not explicitly depicted.

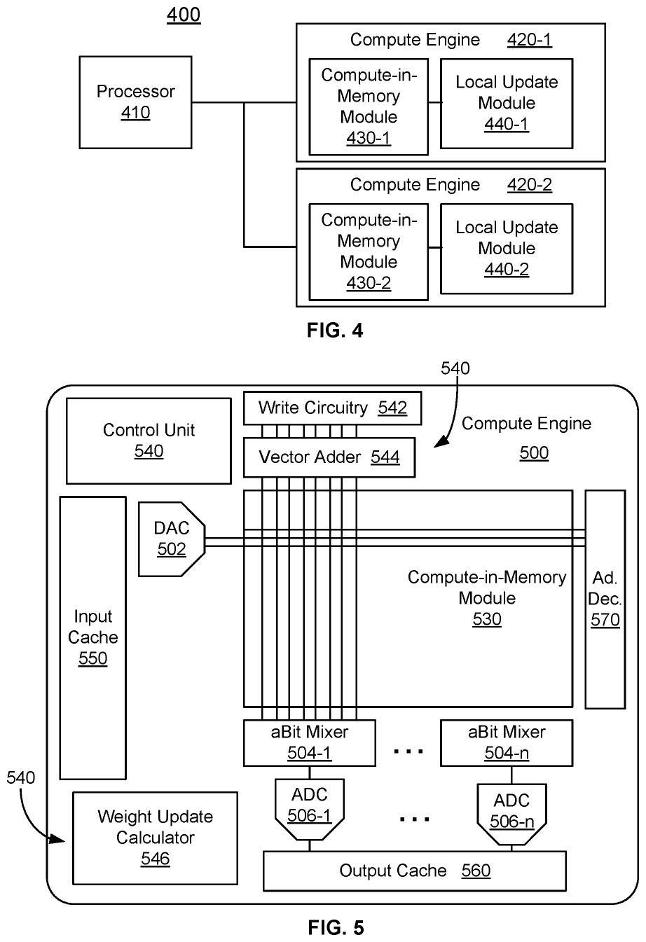

Systems 100, 200, and 300 are indicated as using learning systems 300. As discussed, learning systems 300 may include AI accelerator(s) and/or other components configured for training and/or use of models. FIGS. 4-6B depict an embodiment of a learning system usable for edge devices such as edge devices 110, 210, and/or 310.

FIG. 4 depicts system 400 usable in a learning network, such as learning network 130, 230, and/or 330. System 400 may be an artificial intelligence (AI) accelerator that can be deployed for using a model (not explicitly depicted) and for allowing for on-chip training of the model (otherwise known as on-chip learning). System 400 may thus be implemented as a single integrated circuit. System 400 includes processor 410 and compute engines 420-1 and 420-2 (collectively or generically compute engines 420). Other components, for example a cache or another additional memory, mechanism(s) for applying activation functions, and/or other modules, may be present in system 400. Although a single processor 410 is shown, in some embodiments multiple processors may be used. In some embodiments, processor 410 is a reduced instruction set computer (RISC) processor. In other embodiments, different and/or additional processor(s) may be used. Processor 410 implements instruction set(s) used in controlling compute engines 420.

Compute engines 420 are configured to perform, efficiently and in parallel, tasks used in training and/or using a model. Although two compute engines 420 are shown, another number (generally more) may be present. Compute engines 420 are coupled with and receive commands from processor 410. Compute engines 420-1 and 420-2 include compute-in-memory (CIM) modules 430-1 and 430-2 (collectively or generically CIM module 430) and local update (LU) modules 440-1 and 440-3 (collectively or generically LU module 440). Although one CIM module 430 and one LU module 440 is shown in each compute engine 420, a compute engine may include another number of CIM modules 430 and/or another number of LU modules 440. For example, a compute engine might include three CIM modules 430 and one LU module 440, one CIM module 430 and two LU modules 440, or two CIM modules 430 and two LU modules 440.

CIM module 430 is a hardware module that stores data and performs operations. In some embodiments, CIM module 430 stores weights for the model. CIM module 430 also performs operations using the weights. More specifically, CIM module 430 performs vector-matrix multiplications, where the vector may be an input vector provided using processor 410 and the matrix may be weights (i.e. data/parameters) stored by CIM module 430. Thus, CIM module 430 may be considered to include a memory (e.g. that stores the weights) and compute hardware (e.g. that performs the vector-matrix multiplication of the stored weights). In some embodiments, the vector may be a matrix (i.e. an n×m vector where n>1 and m>1). For example, CIM module 430 may include an analog static random access memory (SRAM) having multiple SRAM cells and configured to provide output(s) (e.g. voltage(s)) corresponding to the data (weight/parameter) stored in each cell of the SRAM multiplied by a corresponding element of the input vector. In some embodiments CIM module 430 may include a digital static SRAM having multiple SRAM cells and configured to provide output(s) corresponding to the data (weight/parameter) stored in each cell of the digital SRAM multiplied by a corresponding element of the input vector. In some embodiments, CIM module 430 may include an analog resistive random access memory (RAM) configured to provide output (e.g. voltage(s)) corresponding to the impedance of each cell multiplied by the corresponding element of the input vector. Other configurations of CIM module 530 are possible. Each CIM module 430 thus stores weights corresponding to a matrix in its cells and is configured to perform a vector-matrix multiplication of the matrix with an input vector.

In order to facilitate on-chip learning, LU modules 440 are provided. LU modules 440-1 and 440-2 are coupled with the corresponding CIM modules 430-1 and 430-2, respectively. LU modules 440 are used to update the weights (or other data) stored in CIM modules 430. LU modules 440 are considered local because LU modules 440 are in proximity and CIM modules 430. For example, LU modules 440 may reside on the same integrated circuit as CIM modules 430. In some embodiments LU modules 440-1 and 440-2 for a particular compute engine reside in the same integrated circuit as the CIM modules 430-1 and 430-2, respectively, for the compute engine 420-1 and 420-2. In some embodiments, LU module 440 is considered local because it is fabricated on the same substrate (e.g. the same silicon wafer) as the corresponding CIM module 430. In some embodiments, LU modules 440 are also used in determining the weight updates. In other embodiments, a separate component may calculate the weight updates. For example, in addition to or in lieu of LU modules 440, the weight updates may be determined by processor 410, in software by other processor(s) not part of system 400 (not shown), by other hardware that is part of system 400, by other hardware outside of system 400, and/or some combination thereof.

System 400 may thus be considered to form some or all of a learning network. Such a learning network typically includes layers of weights (corresponding to synapses) interleaved with activation layers (corresponding to neurons). In operation, a layer of weights receives an input signal and outputs a weighted signal that corresponds to a vector-matrix multiplication of the input signal with the weights. An activation layer receives the weighted signal from the adjacent layer of weights and applies the activation function, such as a ReLU or sigmoid. The output of the activation layer may be provided to another weight layer or an output of the system. One or more of the CIM modules 430 corresponds to a layer of weights. For example, if all of the weights in a layer can be stored in the cells of CIM module 430, then system 400 may correspond to two layers of weights. In such a case, the input vector may be provided (e.g. from a cache, from a source not shown as part of system 400, or from another source) to CIM module 430-1. CIM module 430-1 performs a vector-matrix multiplication of the input vector with the weights stored in its cells. The weighted output may be provided to component(s) corresponding to an activation layer. For example, processor 410 may apply the activation function and/or other component(s) (not shown) may be used. The output of the activation layer may be provided to CIM module 430-2. CIM module 430-2 performs a vector-matrix multiplication of the input vector (the activation layer) with the weights stored in its cells. The output may be provided to another activation layer, such as processor 410 and/or other component(s) (not shown). If all of the weights in a weight layer cannot be stored in a single CIM module 430, then CIM modules 430 may include only a portion of the weights in a weight layer. In such embodiments, portion(s) of the same input vector may be provided to each CIM module 430. The output of CIM modules 430 is provided to an activation layer. Thus, inferences may be performed using system 400. During training of the learning network, updates to the weights in the weight layer(s) are determined. Thus, the weights in (i.e. parameters stored in cells of) CIM modules 430 are updated using LU modules 440.

Using system 400, efficiency and performance of a learning network may be improved. Use of CIM modules 430 may dramatically reduce the time to perform the vector-matrix multiplication that provides the weighted signal. Thus, performing inference(s) using system 400 may require less time and power. This may improve efficiency of training and use of the model. LU modules 440 allow for local updates to the weights in CIM modules 430. This may reduce the data movement that may otherwise be required for weight updates. Consequently, the time taken for training may be greatly reduced. In some embodiments, the time taken for a weight update using LU modules 440 may be an order of magnitude less (i.e. require one-tenth the time) than if updates are not performed locally. Efficiency and performance of a learning network provided using system 400 may be increased.

FIG. 5 depicts an embodiment of compute engine 500 usable in an AI accelerator and capable of performing local updates. Compute engine 500 may be a hardware compute engine analogous to compute engines 120. Compute engine 500 thus includes CIM module 530 and LU module 540 analogous to CIM modules 430 and LU modules 440, respectively. Compute engine 500 also includes analog bit mixer (aBit mixer) 504-1 through 504-n (generically or collectively 504), analog to digital converter(s) (ADC(s)) 506-1 through 506-n (generically or collectively 506), input cache 550, output cache 560, and address decoder 570. Although particular numbers of components 502, 504, 506, 530, 540, 542, 544, 546, 360, and 570 are shown, another number of one or more components 502, 504, 506, 530, 540, 542, 544, 546, 360, and 570 may be present.

CIM module 530 is a hardware module that stores data corresponding to weights and performs vector-matrix multiplications. The vector is an input vector provided to CIM module 530 (e.g. via input cache 550) and the matrix includes the weights stored by CIM module 530. In some embodiments, the vector may be a matrix. Examples of embodiments CIM modules that may be used in CIM module 530 include but are not limited to SRAM CIM modules, resistive CIM modules, and digital SRAM modules.

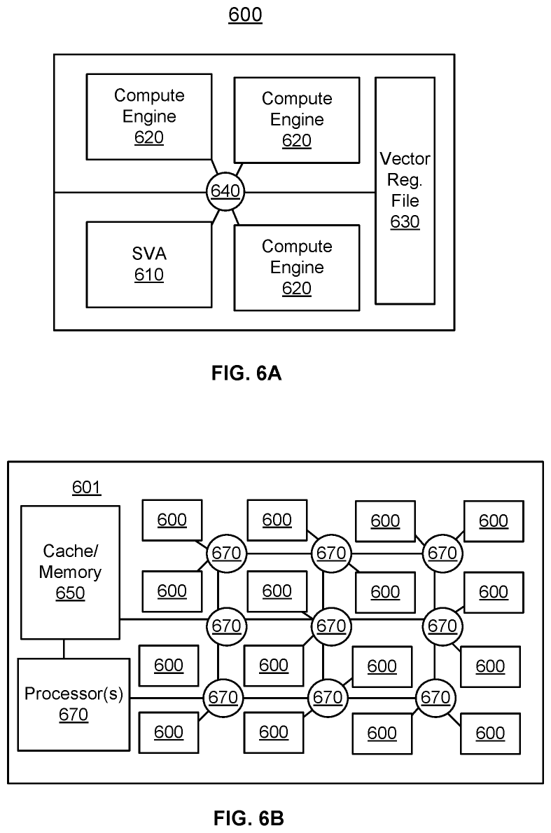

Compute engines 120 and/or 200 may be combined in a variety of architectures. For example, FIGS. 6A-6B depict an embodiment of an architecture including compute engines 620 and usable in an AI accelerator. The architecture includes tile 600 depicted in FIG. 6A. Tile 600 includes SVA 610, compute engines 620, router 640, and vector register file 630. Although one SVA 610, three compute engines 620, one vector register file 630, and one router 640 are shown, different numbers of any or all components 610, 620, 630, and/or 640 may be present.

Compute engines 620 are analogous to compute engine(s) 120 and/or 200. Thus, each compute engine 620 has a CIM module analogous to CIM module 130/230 and an LU module analogous to LU module 140/240. In some embodiments, each compute engine 620 has the same size (e.g. the same size CIM module). In other embodiments, compute engines 620 may have different sizes. Although not indicated as part of compute engines 620, SVA 610 may be analogous to weight update calculator 246 and/or SVA 810. Thus, SVA 610 may determine outer products for weight updates, obtain partial sums for weight updates, perform batch normalization, and/or apply activation functions. Input vectors, weights to be loaded in CIM modules, and other data may be provided to tile 600 via vector register file 630. Similarly, outputs of compute engines 620 may be provided from tile 600 via vector register file 620. In some embodiments, vector register file 640 is a two port register file having two read and write ports and a single scalar read. Router 640 may route data (e.g. input vectors) to the appropriate portions of compute engines 620 as well as to and/or from vector register file 630.

FIG. 6B depicts an embodiment of higher level architecture 601 employing multiple tiles 600. An AI accelerator may include or be architecture 601. In some embodiments, architecture 601 may be considered a network on a chip (NoC). Architecture 601 may also provide extended data availability and protection (EDAP) as well as a significant improvement in performance described in the context of system 60 and embodiments of compute engine 200. In addition to tiles 600, architecture 601 includes cache (or other memory) 650, processor(s) 660, and routers 670. Other and/or different components may be included. Processor(s) 660 may include one or more RISC processors, which control operation and communication of tiles 600. Routers 670 route data and commands between tiles 600.

Thus, systems 100, 200, and/or 300 may incorporate systems 400, 500, 600, and/or 601 in learning systems 130, 230, and/or 330. As a result, additional benefits of systems 400, 500, 600 may be achieved.

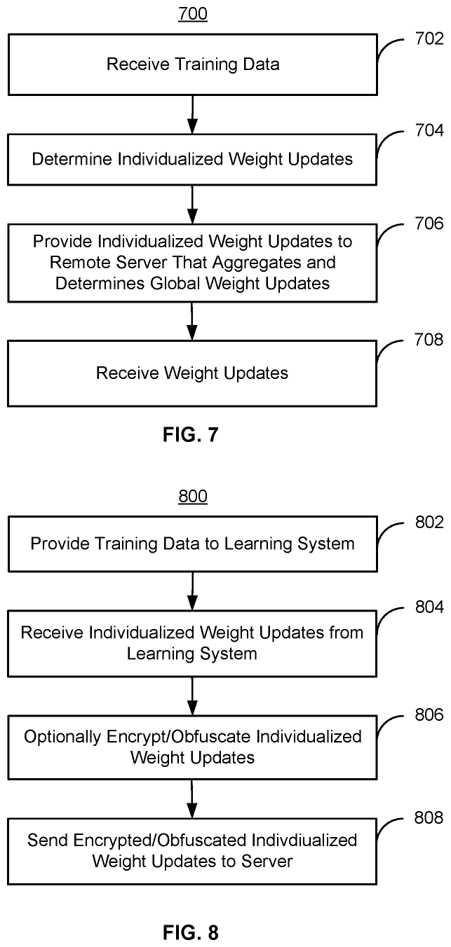

FIG. 7 is a flow chart depicting an embodiment of method 700 for securely updating models for edge devices. Method 700 is described in the context of system 100, but may be used in connection with other systems including but not limited to system(s) 200 and/or 300. Although particular processes are shown in an order, the processes may be performed in another order, including in parallel. Further, processes may have substeps.

Training data for a model corresponding to an app on an edge device is received, at 702. The training data includes or consists of training data that is specific to the edge device. Individualized weight updates are determined on the edge device, at 704. These individualized weight updates are provided to a remote server, at 706. Although the individualized weight updates are provided to the server, the training data specific to the edge devices is not provided. Instead, this local training data remains on the edge devices. The remote server may aggregate the individualized weight updates for the edge device with analogous weight updates for other edge devices. The server determines global weight updates. The weight updates are received at the edge device, at 708. Thus, weights for the model may be securely updated.

For example, training data for model 116 corresponding to app 112 on edge device 110 is received by update module 120, at 702. The training data includes or consists of training data that is specific to the edge device. Individualized weight updates are determined using update module 120, at 704. Stated differently, update module 120 is used to train model 116. In some embodiments, update module 120 uses learning system 130 or another AI accelerator to determine the individualized weight updates.

The individualized weight updates are provided by update module 120 to server 150, at 706. However, update module 120 does not send to server 150 the training data specific to edge devices 110.

Server 150 may aggregate the individualized weight updates for edge device 110 with analogous weight updates for other edge devices 110-2 and 110-3 that also include update modules. In some embodiments, server 150 receives training data for edge device 110-4 that does not include an update module. In such embodiments, server 150 may also determine individualized weight updates for edge device 110-4. Server, 150 incorporates the individualized weight updates for edge devices 110, 110-2, 110-3, and 110-4 into a determination of the global weight updates. In other embodiments, server 15 does not receive training data (or individualized weight updates) from edge devices 110-4. In such embodiments, the global weight updates determined by server 150 are for edge devices 110, 110-2, and 110-3 having an update module. In some embodiments, server 150 provides the global updates to app server 142. In some embodiments, app server 142 receives or determines weight updates for edge devices 110-4. In such embodiments, app server provides weight updates that incorporate the global weight updates from server 150 and the individualized weight updates of edge devices 110-4. The weight updates are received at the edge device 110, at 708. Thus, weights for the model may be securely updated.

Thus, using method 700 weight updates may be determined while maintaining the security for private data of users of edge devices. Thus, the benefits described herein may be achieved. For example, performance and security may be improved.

FIG. 8 is a flow chart depicting an embodiment of method 800 for securely updating models for edge devices. Method 800 is described in the context of system 100, but may be used in connection with other systems including but not limited to system(s) 200 and/or 300. Although particular processes are shown in an order, the processes may be performed in another order, including in parallel. Further, processes may have substeps. In particular, method 800 determines individualized weight updates using a learning system.

Training data specific to the edge device is provided to the learning system, at 802. The learning system may include an AI accelerator and may store weights for the model. The learning system determines the individualized weight updates using the training data. In some embodiments, backpropagation or another learning technique may be used to determine the weight updates. In some embodiments, the weights stored in the learning system may be updated as part of 802. In some embodiments, the weights are not updated.

The individualized weight updates are received from the learning system, at 804. The individualized weight updates are prepared for transmission. For example, the weight updates may be encrypted, quantized, have noise introduced (or otherwise obfuscated) and/or otherwise processed. The encrypted and/or obfuscated individualized weight updates are provided to the server, at 808. Thus, the server may then determine global weight updates and/or otherwise use the individualized weight updates.

For example, training data may be provided to learning system 130 by update module 120, at 802. Learning system 130 may be utilized to train the corresponding model 316. Stated differently, individualized weight updates are determined by learning system 130. The individualized weight updates are received at update module 120, at 804.

Update module 120 prepares the individualized weight updates for transmission, for example by encrypting, obfuscating, or otherwise processing the individualized weight updates. The encrypted and/or obfuscated individualized weight updates are provided by update module 120 to server 150, at 808. Thus, the server may then determine global weight updates and/or otherwise use the individualized weight updates.

Thus, using method 800 weight updates may be determined while maintaining the security for private data of users of edge devices. Thus, the benefits described herein may be achieved. For example, performance and security may be improved.

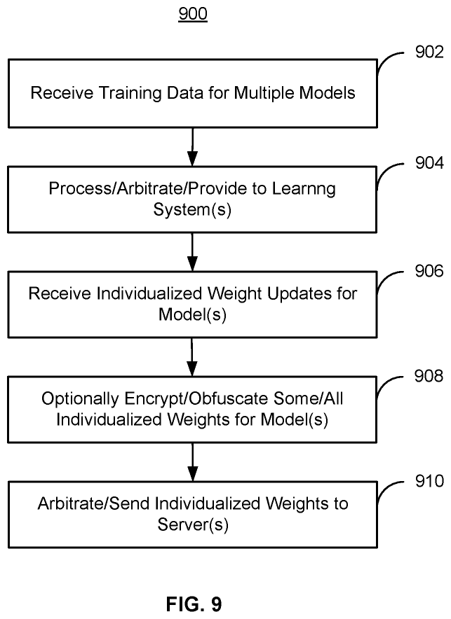

FIG. 9 is a flow chart depicting an embodiment of method 900 for securely updating models for edge devices. Method 900 is described in the context of system 300, but may be used in connection with other systems including but not limited to system(s) 100 and/or 200. Although particular processes are shown in an order, the processes may be performed in another order, including in parallel. Further, processes may have substeps. In particular, method 800 determines individualized weight updates using a learning system.

Training data specific to the edge device and for multiple models on the devices is received, at 902. The training data for each model may be processed and prepared for use by a learning system, at 904. For example, the data for models may be ranked and/or ordered so that the appropriate data for each of the models on the device is provided to the learning system at the appropriate time. The learning system may include an AI accelerator and may store weights for the models. In some embodiments, the learning system may have sufficient capacity to store weights for all models. In some embodiments, the appropriate weights for each model are stored in advance of training. Thus, the weights stored by the learning system may be swapped. The learning system determines the individualized weight updates using the training data.

The individualized weight updates for each model are received from the learning system, at 906. The individualized weight updates are prepared for transmission, at 908. For example, the weight updates may be encrypted, quantized, have noise introduced (or otherwise obfuscated) and/or otherwise processed. The encrypted and/or obfuscated individualized weight updates are provided to the server, at 910. Thus, the server may then determine global weight updates and/or otherwise use the individualized weight updates.

For example, the training data specific to edge device 310 and for multiple models 316-1, 316-2, and 316-3 is received by update module 320, at 902. The training data for each model may be processed and prepared for use by learning system 330, at 904. For example, the data for models may be ranked and/or ordered so that the appropriate data for each of the models on the device is provided to learning system 330 at the appropriate time. Learning system 330 determines the individualized weight updates using the training data.

The individualized weight updates for each model are received by update module 320 from learning system 330, at 906. Update module 320 prepares the individualized weight updates for transmission, at 908. For example, the weight updates may be encrypted, quantized, have noise introduced (or otherwise obfuscated) and/or otherwise processed. The encrypted and/or obfuscated individualized weight updates are provided to server 350, at 910. For example, the weight updates for models 316-1, 316-2, and 316-3 may be ordered so as to optimize the bandwidth and power consumed and provide the weight updates for particular models in the desired order. For example, a model that is currently not in use may be more likely to be updated and, therefore, have the updates ready to be sent at 910. Thus, server 350 may determine global weight updates for each model 316-1, 316-2, and 316-3 and/or otherwise use the individualized weight updates.

Thus, using method 900 weight updates may be determined while maintaining the security for private data of users of edge devices. Further, the updates for multiple models may be scheduled, tracked, and processed as desired. Consequently, bandwidth and/or power may be conserved. Thus, the benefits described herein may be achieved. For example, performance and security may be improved.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
an update module, residing on an edge device and configured to
receive training data for a model corresponding to an application, the model and the application residing on the edge device, at least a portion of the training data being generated at the edge device and specific to the edge device, the model including a plurality of weights;
provide the training data to a learning system configured to determine individualized weight updates for the model using the training data, the learning system residing on the edge device;
receive, from the learning system, the individualized weight updates for the model; and
provide from the edge device to a remote server, the individualized weight updates for the model;
wherein the remote server determines global weight updates for the model based on the individualized weight updates from the edge device and distinct individual weight updates for the model from at least one distinct edge device;
wherein the edge device receives weight updates for the model, the weight updates being based on the global weight updates; and
wherein the at least the portion of the training data remains on the edge device.

2. The system of claim 1, wherein the edge device includes at least one additional application and at least one additional model corresponding to the at least one additional application, wherein the update module is further configured to:
receive additional training data for the at least one additional model, at least a portion of the additional training data being generated at the edge device and specific to the edge device, the at least one additional model including an additional plurality of weights;
provide the additional training data to the learning system configured to determine additional individualized weight updates for the at least one additional model using the additional training data;
receive, from the learning system, the additional individualized weight updates; and
provide from the edge device to the remote server, the additional individualized weight updates for the model;
wherein the remote server determines additional global weight updates for the at least one additional model based on the additional individualized weight updates from the edge device and additional distinct individual weight updates for the at least one additional model from at least one distinct edge device;
wherein the edge device receives additional weight updates for the at least one additional model, the additional weight updates being based on the additional global weight updates; and
wherein the at least the portion of the additional training data remains on the edge device.

3. The system of claim 2, wherein the learning system includes a plurality of learning subsystems each of the learning subsystems being configured for one of the model and the at least one additional model.

4. The system of claim 1, wherein the update module is further configured to encrypt the individualized weight updates to form encrypted individualized weight updates; and
wherein to provide the individualized weight updates, the update module is further configured to provide the encrypted individualized weight updates.

5. The system of claim 1, wherein the learning system includes a hardware vector-matrix multiplication accelerator.

6. The system of claim 1, wherein the weight updates are received by the update module and provided by the update module to the learning system.

7. The system of claim 1, wherein the edge device includes an additional component that generates the training data, the update module being configured to receive the training data from the additional component such that the training data remains separate from the application.

8. The system of claim 1, wherein the weight updates are received at the edge device from an application server corresponding to the application.

9. The system of claim 8, wherein the at least the portion of the training data and the individualized weight updates remain separate from the application server.

10. The system of claim 1, wherein no part of the at least the portion of the training data leaves the edge device for updating of the model.

11. A method, comprising:
receiving, on an edge device, training data for a model corresponding to an application, the model and the application residing on the edge device, at least a portion of the training data being generated at the edge device and specific to the edge device;
providing the training data to a learning system configured to determine individualized weight updates for the model using the training data, the learning system residing on the edge device;
receiving, from the learning system, the individualized weight updates for the model;
providing, from the edge device to a remote server, the individualized weight updates for the model, wherein the remote server determines global weight updates for the model based on the individualized weight updates from the edge device and additional individual weight updates for the model from at least one additional edge device;
wherein the edge device receives weight updates for the model, the weight updates being based on the global weight updates; and
wherein the at least the portion of the training data remains on the edge device.

12. The method of claim 11, wherein the edge device includes at least one additional application and at least one additional model corresponding to the at least one additional application, the method further comprising:
receiving additional training data for the at least one additional model, at least a portion of the additional training data being generated at the edge device and specific to the edge device, the at least one additional model including an additional plurality of weights;
providing the additional training data to the learning system configured to determine additional individualized weight updates for the at least one additional model using the additional training data;
receiving, from the learning system, the additional individualized weight updates; and
providing from the edge device to the remote server, the additional individualized weight updates for the model;
wherein the remote server determines additional global weight updates for the at least one additional model based on the additional individualized weight updates from the edge device and additional distinct individual weight updates for the at least one additional model from at least one distinct edge device;
wherein the edge device receives additional weight updates for the at least one additional model, the additional weight updates being based on the additional global weight updates; and
wherein the at least the portion of the additional training data remains on the edge device.

13. The method of claim 12, wherein the learning system includes a plurality of learning subsystems each of the learning subsystems being configured for one of the model and the at least one additional model.

14. The method of claim 11, further comprising:
encrypting the individualized weight updates to form encrypted individualized weight updates; and
wherein the providing the individualized weight updates further includes providing the encrypted individualized weight updates.

15. The method of claim 11, wherein the learning system includes a hardware vector-matrix multiplication accelerator.

16. The method of claim 11, wherein the edge device includes an additional component that generates the training data, and wherein the receiving further includes:
receiving the training data from the additional component such that the training data remains separate from the application.

17. The method of claim 11, wherein the weight updates are received at the edge device from an application server corresponding to the application.

18. The method of claim 17, wherein the at least the portion of the training data and the individualized weight updates remain separate from the application server.

19. The method of claim 11, wherein no part of the at least the portion of the training data leaves the edge device for updating of the model.

20. A computer program product embodied in a non-transitory computer readable medium and comprising computer instructions for:
receiving, on an edge device, training data for a model corresponding to an application, the model and the application residing on the edge device, at least a portion of the training data being generated at the edge device and specific to the edge device;
determining, on the edge device, individualized weight updates for the model using the training data;
providing the training data to a learning system configured to determine individualized weight updates for the model using the training data, the learning system residing on the edge device;
receiving, from the learning system, the individualized weight updates for the model;
providing, from the edge device to a remote server, the individualized weight updates for the model, wherein the remote server determines global weight updates for the model based on the individualized weight updates from the edge device and additional individual weight updates for the model from at least one additional edge device;
wherein the edge device receives weight updates for the model, the weight updates being based on the global weight updates; and
wherein the at least the portion of the training data remains on the edge device.
